(19) United States
(12) Patent Application Publication
(10) Pub. No.: US 2021/0055415 A1
(43) Pub. Date: Feb. 25, 2021

(54) METHOD AND DEVICE FOR OPERATING ULTRASONIC SENSORS OF A VEHICLE

(71) Applicant: Robert Bosch GmbH, Stuttgart (DE)

(72) Inventors: Timo Koenig, Unterheinriet (DE); Christian Beer, Obersulm (DE); Philipp Sauer, Tamm (DE); Simon Weissenmayer, Flein (DE); Michael Schumann, Stuttgart (DE)

(21) Appl. No.: 17/040,381

(22) PCT Filed: Apr. 25, 2019
(86) PCT No.: PCT/EP2019/060633

§ 371 Date: Sep. 22, 2020

(30) Foreign Application Priority Data
May 2, 2018 (DE) 10 2018 206 722.8

(51) Int. Cl. G01S 15/931; G01S 15/88; G01S 15/89; G01B 17/08

(52) U.S. Cl. CPC G01S 15/931; G01S 15/885; B60W 2420/54; G01B 17/08; G01S 15/89

(57) ABSTRACT

A method for operating ultrasonic sensors of a vehicle. In the method, front ultrasonic sensors of the vehicle are used to detect wind noise at the vehicle, rear ultrasonic sensors of the vehicle are used to detect a road condition in the area of the vehicle, and lateral ultrasonic sensors of the vehicle are used to detect objects in the area of the vehicle.

### FIELD

The present invention relates to a method and a device for operating ultrasonic sensors of a vehicle.

### BACKGROUND INFORMATION

Obstacles in the surroundings of a vehicle may be detected at low speeds of the vehicle using ultrasonic sensors. At higher speeds, the detection is made more difficult by airflow noises and tire noises.

### SUMMARY

A method for operating ultrasonic sensors of a vehicle and a device for operating ultrasonic sensors of a vehicle, and finally a corresponding computer program product and a machine-readable memory medium are provided in accordance with the present invention. Advantageous refinements and improvements of the present invention result from the description herein.

Specific embodiments of the present invention may advantageously enable differently oriented ultrasonic sensors of a vehicle to be used for different tasks. The ultrasonic sensors may each be used for a task for which they are particularly well suitable.

In accordance with an example embodiment of the present invention, a method for operating ultrasonic sensors of a vehicle is provided, which is characterized in that front ultrasonic sensors of the vehicle are used to detect wind noises at the vehicle, rear ultrasonic sensors of the vehicle are used to detect a road condition in the area of the vehicle, and lateral ultrasonic sensors of the vehicle are used to detect objects in the area of the vehicle.

Features and variants of specific embodiments of the present invention may be considered to be based, among other things, on the features and findings described hereinafter.

In accordance with an example embodiment of the present invention, a vehicle may include ultrasonic sensors oriented in various directions. If the ultrasonic sensors are actively operated, they emit ultrasonic pulses in an orientation-dependent detection area. The ultrasonic pulses are partially reflected at objects in the detection area and received again as echoes at the ultrasonic sensor. The echoes have a significantly lower intensity than the ultrasonic pulses. A distance to the particular object may be determined from a propagation time of the ultrasonic pulses in the echoes. In addition to the echoes, the ultrasonic sensors detect ambient noises if they are in a reception frequency band of the ultrasonic sensors. If the ambient noises are louder than the echoes, the ambient noises may obstruct the reception of the echoes.

During travel, an airflow resulting from a local wind speed and a local wind direction and an instantaneous vehicle speed flows around the vehicle. The airflow causes noises at a body of the vehicle, which may be referred to as wind noises and may be detected by the ultrasonic sensors. Depending on the vehicle speed, wind speed, and wind direction, the wind noises may be louder than the echoes.

Depending on the vehicle speed, tires of the vehicle cause noises when rolling on the roadway, which may be referred to as rolling noises and may be detected by the ultrasonic sensors.

The rolling noises may be louder than the echoes depending on the vehicle speed.

If a road condition of the roadway is damp or wet, the tires cause additional noises when rolling, which may be referred to, for example, as wet hissing and may be detected by the ultrasonic sensors. Depending on the road condition and vehicle speed, the wet hissing may be louder than the echoes.

Independently of the vehicle speed, other sources of noise generate external noises. For example, other vehicles generate wind noises, rolling noises, and, in the case of a damp or wet roadway, also wet hissing. These external noises may also be detected by the ultrasonic sensors.

The different ambient noises and external noises are mutually overlaid, so that a composite ambient noise is detected at each ultrasonic sensor.

The different ambient noises have different intensities at the differently oriented ultrasonic sensors. The wind noises have a high intensity at the ultrasonic sensors oriented forward. The rolling noises and the wet hissing have a high intensity at the sensors oriented to the rear. The external noises of other vehicles have a high intensity at the ultrasonic sensors oriented to the side.

Noise levels detected at the ultrasonic sensors may be evaluated to detect the wind noises and/or to detect the road condition and/or to detect the objects. The external noises may be quantified in a numeric value. The numeric value may be referred to as a noise level. The noise level thus characterizes an intensity of the ambient noises at an ultrasonic sensor. The noise level is already determined in the ultrasonic sensor and is mapped in a receive signal of the ultrasonic sensor. The further data processing may be carried out with reduced computing time due to the use of the noise level.

Echoes detected at the ultrasonic sensors may be evaluated to detect the objects. The objects may also be actively detected. A distance to the objects may thus also be determined from the propagation time of the echo signals. The external noises emitted by the objects may additionally be evaluated on the basis of the received noise levels.

Wind noises and/or objects mapped in pieces of sensor information of the ultrasonic sensors oriented to the rear may be compensated for using wind noises detected at the ultrasonic sensors oriented forward and/or the objects detected at the ultrasonic sensors oriented to the side. Wind noises and/or road conditions mapped in pieces of sensor information of the ultrasonic sensors oriented to the side may be compensated for using the wind noises detected at the ultrasonic sensors oriented forward and/or the road condition detected at the ultrasonic sensors oriented to the rear. Objects and/or the road condition mapped in pieces of sensor information of the ultrasonic sensors oriented forward may be compensated for using the road condition detected at the ultrasonic sensors oriented to the rear and/or the objects detected at the ultrasonic sensors oriented to the side. Since different components of the ambient noises may each be detected particularly well at the differently oriented ultrasonic sensors, the components of the ambient noises which are detected less well in each case may be compensated for.

Pieces of sensor information of ultrasonic sensors situated in pairs symmetrically with respect to a vehicle longitudinal axis of the vehicle may be evaluated together. Noises of the ego vehicle are essentially identical on both sides of the vehicle. If both sides detect different noises, they are highly probably external noises from an external noise source on one side of the vehicle.

Pieces of sensor information of the ultrasonic sensors arranged on one vehicle side may be used to detect passing vehicles or passed other vehicles on the vehicle side. Passing vehicles and passed vehicles drive at a different speed. A passed vehicle is thus first detected at the front sensors. A passing vehicle is first detected at the rear sensors.

The method may be implemented, for example, in software or hardware or in a mixed form of software and hardware, for example, in a control unit.

The present invention furthermore provides a device which is designed to carry out, activate, and/or implement the steps of a variant of the method presented here in corresponding units.

The device may be an electrical device having at least one processing unit for processing signals or data, at least one memory unit for storing signals or data, and at least one interface and/or a communication interface for reading in or outputting data which are embedded in a communication protocol. The processing unit may be, for example, a signal processor, a so-called system ASIC, or a microcontroller for processing sensor signals and outputting data signals as a function of the sensor signals. The memory unit may be, for example, a flash memory, an EPROM, or a magnetic memory unit. The interface may be designed as a sensor interface for reading in the sensor signals from a sensor and/or as an actuator interface for outputting the data signals and/or control signals to an actuator. The communication interface may be designed to read in or output the data in a wireless and/or hard-wired manner. The interfaces may also be software modules, which are provided on a microcontroller along with other software modules, for example.

In accordance with the present invention, a computer program product or computer program is also advantageous, having program code which may be stored on a machine-readable carrier or memory medium such as a semiconductor memory, a hard drive memory, or an optical memory and is used to carry out, implement, and/or activate the steps of the method according to one of the above-described specific embodiments, in particular when the program product or program is executed on a computer or a device.

It is to be noted that some of the possible features and advantages of the present invention are described herein with reference to different specific embodiments. Those skilled in the art recognize that the features of the method and the device may be combined, adapted, or exchanged suitably to arrive at further specific embodiments of the present invention.

### BRIEF DESCRIPTION OF THE DRAWINGS

Specific embodiments of the present invention are described hereinafter with reference to the FIGURES, with neither the FIGURES nor the description to be interpreted as restricting the present invention.

FIG. 1 shows a depiction of a vehicle having differently oriented ultrasonic sensors and a device according to one exemplary embodiment of the present invention.

The FIGURE is merely schematic and is not true to scale. Identical reference numerals identify identical or identically acting features in the FIGURE.

### DETAILED DESCRIPTION OF EXAMPLE EMBODIMENTS

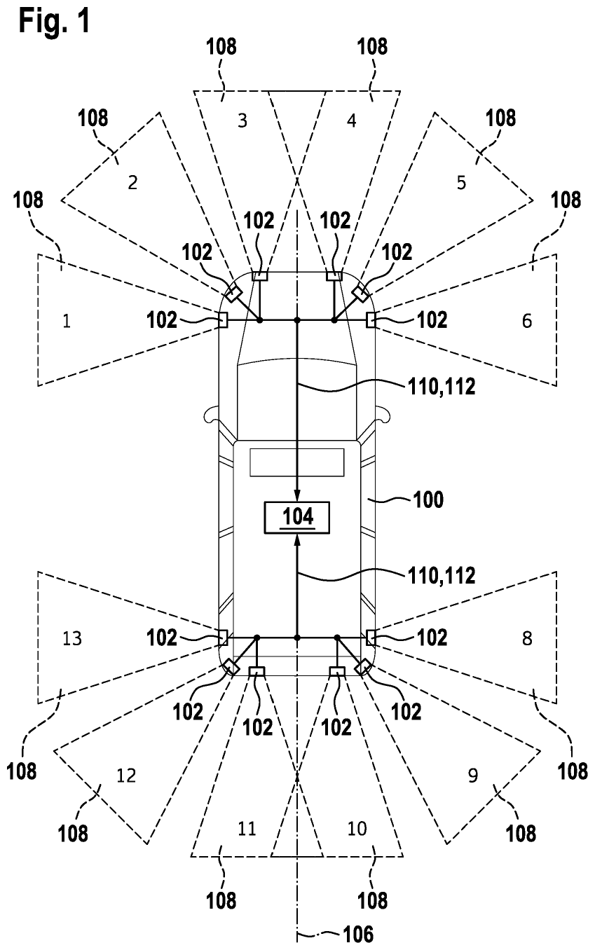

FIG. 1 shows a depiction of a vehicle 100 having differently oriented ultrasonic sensors 102 and a device 104 according to one exemplary embodiment. Ultrasonic sensors 102 are situated distributed over vehicle 100. Ultrasonic sensors 102 are consecutively numbered from one through thirteen clockwise here.

First ultrasonic sensor 102 is situated here at a left front corner of vehicle 100 and is oriented to the left with respect to a vehicle longitudinal axis 106 of vehicle 100. Second ultrasonic sensor 102 is also situated on the left front corner and is oriented forward and diagonally to the left with respect to vehicle longitudinal axis 106. Third ultrasonic sensor 102 is also situated on the left front corner and oriented forward.

Fourth ultrasonic sensor 102 is situated on a right front corner of vehicle 100, symmetrically in relation to third ultrasonic sensor 102 with respect to vehicle longitudinal axis 106, and is oriented forward like third ultrasonic sensor 102. Fifth ultrasonic sensor 102 is also situated on the right front corner, symmetrically in relation to second ultrasonic sensor 102 with respect to vehicle longitudinal axis 106 and is oriented forward and diagonally to the right with respect to vehicle longitudinal axis 106. Sixth ultrasonic sensor 102 is also situated on the right front corner, symmetrically in relation to first ultrasonic sensor 102 with respect to vehicle longitudinal axis 106, and is oriented to the right with respect to vehicle longitudinal axis 106.

The number seven is not assigned.

Eighth ultrasonic sensor 102 is situated on a right rear corner of vehicle 100 and is oriented to the right with respect to vehicle longitudinal axis 106. Ninth ultrasonic sensor 102 is also situated on the right rear corner and is oriented to the rear and diagonally to the right with respect to vehicle longitudinal axis 106. Tenth ultrasonic sensor 102 is also situated on the right rear corner and oriented to the rear.

Eleventh ultrasonic sensor 102 is situated on a left rear corner of vehicle 100, symmetrically to tenth ultrasonic sensor 102 with respect to vehicle longitudinal axis 106, and is oriented to the rear like tenth ultrasonic sensor 102. Twelfth ultrasonic sensor 102 is also situated on the left rear corner, symmetrically to ninth ultrasonic sensor 102 with respect to vehicle longitudinal axis 106, and oriented to the rear and diagonally to the left with respect to vehicle longitudinal axis 106. Thirteenth ultrasonic sensor 102 is also situated on the left rear corner, symmetrically to eighth ultrasonic sensor 102 with respect to vehicle longitudinal axis 106, and is oriented to the left with respect to vehicle longitudinal axis 106.

Each ultrasonic sensor 102 may carry out echolocation of objects in its particular detection area 108 using emitted ultrasound and map a distance to the object in a piece of sensor information 110. Alternatively or additionally, each ultrasonic sensor 102 may detect ambient noises and map them in sensor information 110. An intensity of the ambient noises is mapped in each case in a noise level 112 of sensor information 110.

Pieces of sensor information 110 of all ultrasonic sensors 102 are read in by device 104.

When a vehicle 100 drives slowly, for example, during maneuvering, parking, or in a traffic jam, the echolocation functions as intended and few ambient noises are detected. If the ambient noises become louder than the echoes of the ultrasound, the echolocation only still functions to a limited extent.

For example, airflow at a body of vehicle 100 generates a wind noise, which is detected by ultrasonic sensors 102. Furthermore, tires of vehicle 100 generate a rolling noise, which is also detected by ultrasonic sensors 102. If a roadway is damp or wet, the tires additionally generate a water noise or wet hissing, which is also detected by ultrasonic sensors 102. The wind noise, the rolling noise, and the wet hissing are included with external noises of other noise sources in the ambient noise. At least the wind noise, the rolling noise, and the water noise become louder with increasing speed of vehicle 100.

In accordance with the exm, pieces of sensor information 110 from ultrasonic sensors 102 oriented essentially forward are used to detect the wind noise. Pieces of sensor information 110 from ultrasonic sensors 102 oriented essentially to the rear are used to detect the water noise and the rolling noise. Pieces of sensor information 110 of ultrasonic sensors 102 oriented essentially to the side are used to detect external noises of other noise sources.

In other words, a method is presented for sensor selection in the field of wetness detection on the roadway with the aid of ultrasound.

Presently, the roadway wetness or the water column specification in millimeters on a roadway may not be directly measured. A wet roadway may be inferred indirectly from various operating states of the vehicle. This may take place, for example, due to the windshield wiper activity or ESP interventions. A continuous “measurement” of the roadway condition regarding moisture presently does not exist.

For obstacle detection, ultrasonic sensors are attached in the vicinity of the wheel cases. One significant problem in the use of obstacle detection during faster travel are the driving noises, which are then overlaid on the echo emitted by the sensors and thus sometimes severely restrict the distance measurement. The more water from the tires sprays against the wheel cases, the louder the driving noise is and the more severe the restriction is. The noise level primarily reaches the sensor directly via the air, but may also be received by the sensor indirectly via structure-borne noise. These noises may be computed as the noise level or as “noise” (disturbance variable, noise value) in the ultrasound control unit. The noise level may be output via CAN to other control units in the vehicle.

Driving tests have shown that the quality of the detection of roadway properties, for example, a wetness detection or a detection of ambient properties, for example, the detection of other vehicles, is strongly dependent on the particular selection of the involved ultrasonic sensors (USS). Not every sensor position (presently up to 12 sensors may be installed per vehicle) is equally well-suited or it may even have a negative influence with respect to the particular detection method. Therefore, a suitable sensor selection plays a very large role in the ability to make robust and high-quality statements with respect to wetness on the roadway.

Various ambient or roadway properties may be detected with the aid of the ultrasonic sensors. These are object detection, wetness detection on the roadway, and wind detection.

In accordance with an example embodiment of the present invention, the wind speed in the longitudinal direction is computed using the noise levels of the front sensors, objects are detected using the noise levels of the lateral sensors, and wetness on the roadway is measured using the noise levels of the rear sensors. Since wind and objects also influence the noise level of the rear sensors, the measurement of the wetness is corrected with the aid of the pieces of wind and object information.

The four laterally situated sensors (numbers 1, 6, 8, 13) are decisive for a detection of objects (other road users, for example, vehicles, trucks, . . . ). The particular difference signal of the noise values of the front sensors (numbers 1, 6) and the rear sensors (numbers 13, 8) is evaluated.

U diff. 1,6 [mV]=U 1 [mV]−U 6 [mV]

U diff. 1, 6>threshold object is a vehicle falling behind another vehicle on the left vehicle side U diff. 1, 6<-threshold object is a vehicle passing the ego vehicle on the right vehicle side.

U diff. 13, 8 behaves in the same way.

In addition, a falling behind or passing process may be concluded via the behavior with respect to time of difference signals U diff. 1, 6 and U diff. 13, 8. During a passing process, an increase of the difference signal first occurs in a vehicle-specific manner on the right side in the travel direction at the front lateral sensors (1, 6), chronologically thereafter corresponding to the difference speed at the rear sensors (8, 13). In the case of a falling-behind process, it is correspondingly the other way around and on the left side. Furthermore, a continuous object (guide rail, wall, . . . ) and its location (distance, left or right) may be concluded with a chronologically (longer) constant difference signal.

For this purpose, various threshold values are used for various types of objects (automobile, truck, . . . ). An inference of the particular object may thus also be drawn during driving operation and validated, for example, using the objects from the radar/LIDAR/camera surroundings. For object detection, the sensors (1, 6, 8, 13) may also emit active ultrasonic signals in the entire feature-specific speed band (presently >=60 km/h) in addition to measuring the noise level and may detect objects with the aid of the received echoes, as long as they are not suppressed by excessively high noise levels.

The four rear sensors (numbers 9, 10, 11, 12) are decisive for a detection of the roadway wetness. The best measurement results with respect to the presently existing roadway wetness may be achieved using this sensor selection. At these sensor positions, for example, the wind influence is least.

If no object is detected in the detection area by the vehicle-specific object detection, all rear sensors (numbers 9, 10, 11, 12) may be used for wetness detection. The sensors may be operated actively or also inactively for this purpose, since the noise value may be ascertained and processed in any case.

If a continuous object (guide rail, etc.) is detected in the detection area by the vehicle-specific object detection (for example, also using radar, camera, or LIDAR), the wetness detection may be suspended. Alternatively, all rear sensors (numbers 9, 10, 11, 12) may nonetheless be incorporated for the wetness detection. However, the sensor values of the rear sensors are reduced by a sensor-specific and possibly object-specific correction value. The object influence on the sensor-specific noise level is thus compensated for.

If a short-term object (vehicle, etc.) is detected in the detection area by the vehicle-specific object detection, the rear sensors (numbers 9, 10, 11, 12) are partially deactivated for wetness detection in an object-specific manner. Object groups are formed in this case, which have a similar influencing pattern (profile and intensity) with respect to the noise level of a single sensor. In accordance with each object group, it is defined which sensors for wetness detection may still supply a contribution to the wetness detection during the influence.

The noise level of all other sensors is not taken into consideration for the computation of the wetness during the time of this influence. For example, in the case of an object type “automobile,” only the two sensors close to the object are deactivated (see also continuous object). In the case of an object type “truck,” in contrast, all rear sensors are not taken into consideration, since presently wetness detection may not be carried out via ultrasonic sensors here.

The continuous noise value of the sensor raw signal is converted into a sensor-individual status. An index (sensor designation) is associated with each sensor:

i=[1 2 3 4 5 6 NaN 8 9 10 11 12 13], since the index 7 is not used.

The result is output as a status vector:

Z=[1 2 3 4 5], the status being interpreted as follows and intermediate values being able to occur:

1: dry

2: damp

3: wet

4: very wet

5: risk of hydroplaning

n: support point of status vector Z

v: speed (dependence)

t: time (dependence)

s(i): sensor selection

s(i).SZ(t): sensor result at point in time t

stst noise: support point value of the noise value

tracker noise: present noise value of the sensor

and may be computed as follows:

$$s ( i ) \cdot SZ ( t ) = \frac{{Σ}_{n = 1}^{5} ( Z ( n ) * \frac{1}{{( s t s {t}_{n o i s e ( i , n , v )} - t r a c k e {r}_{n o i s e} ( i , t ) )}^{2}} )}{{Σ}_{n = 1}^{5} ( \frac{1}{{( s t s {t}_{n o ise ( i , n , v )} - t r a c k e {r}_{n o i s e} ( i , t ) )}^{2}} )}$$

A sensor fusion value is computed across all sensors via a fusion factor from the individually computed sensor-individual results. The dimension of the sensor-individual fusion factor is dependent on the “object detection.”

Examples of various fusion factors k in the case of roadway detected as wet or very wet. The crossed-out sensors are not taken into consideration in each case.

k 1 (i)=[0 0 0 0 0 0 NaN 0 2 4 4 2 0] no object detected

k 2 (i)=[0 0 0 0 0 0 NaN 0 [symbol] 4 2 0] passing vehicle (car) detected

k 3 (i)=[0 0 0 0 0 0 NaN 0 [symbol] 0] passing vehicle (truck) detected

k 4 (i)=[0 0 0 0 0 0 NaN 0 2 4 0] vehicle falling behind (car) detected

Computation of the fused result:

$${SZ}_{f u s ( t )} = \frac{{Σ}_{i = 1}^{13} ( s ( i ) \cdot SZ ( t ) * \frac{k ( i )}{{v}_{{tracker}_{n o i s e ( t )}}} )}{{Σ}_{i = 1}^{13} ( \frac{k ( i )}{{v}_{{tracker}_{n o i s e ( t )}}} )}$$

SZ fus (t): fused result of the wetness detection

v_tracker noise: present vehicle speed

The four front sensors (2, 3, 4, 5) are decisive for a detection of the wind in the vehicle longitudinal direction. The effect is utilized for this purpose that the wind influence on the noise level of the individual sensors occurs more intensely in the front. This effect may be ascertained in an experimental trial and may be mapped in a corresponding model value. Airflow is applied to the vehicle in the longitudinal direction for this purpose (for example, in a wind tunnel). Windspeed-dependent sensor-individual noise values may be mapped therefrom and the following relationship may be formed:

V wind [km/h]=V airflow [km/h]−V vehicle [km/h] (1)

V vehicle=0 km/h (in the wind tunnel) (2)

V airflow [km/h]˜N sensor [mV]*k [km/h/mV] (3)

V wind [km/h]=N sensor [mV]*k[km/h/mV]−V vehicle [km/h] (4)

V: speed

N: noise value “noise”

k: speed-dependent correction factor

or in road driving trial:

V wind [km/h]=V airflow [km/h]−V vehicle [km/h] (1)

V vehicle=0 km/h (windless day) (2)

V airflow [km/h]=V vehicle [km/h] (3:

V airflow [km/h]˜N sensor [mV]*k [km/h/mV] (4)

V wind [km/h]=N sensor [mV]*k[km/h/mV]−V vehicle [km/h] (5)

Since headwind increases the noise level of the four rear sensors in the same way and tailwind reduces it, the windspeed computed using the four front sensors is used to compensate for the noise level of the four rear sensors.

The example embodiment of the present invention may be used in any passenger vehicle having an integrated, automatic parking assistant as a software feature. The method may be used in principle in all vehicles having ultrasonic sensors. Since only an already computed signal is provided on the CAN bus and a warning is output to the driver due to this signal, a minimal implementation using software changes on the ultrasound control unit and on the HMI is possible very cost-effectively.

Finally, it is to be noted that terms such as “having,” “including,” etc. do not exclude other elements or steps and terms such as “a” or “one” do not exclude a plurality.

1-10. (canceled)

11. A method for operating ultrasonic sensors of a vehicle, comprising the following steps:
detecting, using front ultrasonic sensors of the vehicle, wind noises at the vehicle;
detecting, using rear ultrasonic sensors of the vehicle, a road condition in an area of the vehicle; and
detecting, using lateral ultrasonic sensors of the vehicle, objects in the area of the vehicle.

12. The method as recited in claim 11, wherein noise levels detected at the ultrasonic sensors are evaluated to detect the wind noises and/or to detect the road condition and/or to detect the objects.

13. The method as recited in claim 11, wherein echoes detected at the ultrasonic sensors are evaluated to detect the objects.

14. The method as recited in claim 11, wherein wind noises and/or objects mapped in pieces of sensor information of those of the ultrasonic sensors oriented to a rear of the vehicle are compensated for using the detected wind noises and/or the detected objects.

15. The method as recited in claim 11, wherein wind noises and/or road conditions mapped in pieces of sensor information of those of the ultrasonic sensors oriented to the side are compensated for using the detected wind noises and/or the detected road condition.

16. The method as recited in claim 11, wherein pieces of sensor information of the ultrasonic sensors situated in pairs symmetrically with respect to a vehicle longitudinal axis of the vehicle are evaluated together.

17. The method as recited in claim 16, wherein the pieces of sensor information of the ultrasonic sensors situated on one vehicle side are used to detect passing vehicles or passed other vehicles on the vehicle side.

18. A device configured to operate ultrasonic sensors of a vehicle, the device configured to:
detect, using front ultrasonic sensors of the vehicle, wind noises at the vehicle;
detect, using rear ultrasonic sensors of the vehicle, a road condition in an area of the vehicle; and
detect, using lateral ultrasonic sensors of the vehicle, objects in the area of the vehicle.

19. A non-transitory machine-readable memory medium on which is stored a computer program for operating ultrasonic sensors of a vehicle, the computer program, when executed by a computer, causing the computer to perform the following steps:
detecting, using front ultrasonic sensors of the vehicle, wind noises at the vehicle;
detecting, using rear ultrasonic sensors of the vehicle, a road condition in an area of the vehicle; and
detecting, using lateral ultrasonic sensors of the vehicle, objects in the area of the vehicle.
